(19) United States
(12) Patent Application Publication
(10) Pub. No.: US 2018/0352819 A1
(43) Pub. Date: Dec. 13, 2018

(54) Device For Longitudinal Cutting And/Or Stamping Of Dough

(71) Applicant: König Maschinen Gesellschaft m.b.H, Graz (AT)

(72) Inventors: Gernot Maier, Hart bei Graz (AT); Hannes Stelzer, Lannach (AT); Stefan Urschler, Frohnleiten (AT)

(73) Assignee: König Maschinen Gesellschaft m.b.H, Graz (AT)

(21) Appl. No.: 15/781,422

(22) PCT Filed: Dec. 5, 2016
(86) PCT No.: PCT/AT2016/060117

§ 371 Date: Jun. 4, 2018

(30) Foreign Application Priority Data
Dec. 4, 2015 (AT) A 51042/2015

(51) Int. Cl. A21C 11/04; A21C 11/12; A21C 5/00

(52) U.S. Cl. CPC A21C 11/04; A21C 5/003; A21C 11/12

(57) ABSTRACT

A device for longitudinal cutting and/or stamping of dough strips, wherein the tool-receiving shaft thereof is mounted rotatably with both of its ends in bearing cheeks arranged vertically displaceably in recesses of side panels of the device. The bearing cheeks are vertically adjustable by means of an adjustment screw drive that is arranged in each case on the two anchoring boxes of the clamping lever and that adjusts the cutting depth. The clamping lever is equipped with an anchoring mechanism which is arranged inside its connecting strut and reaches into the anchoring box thereof and which has anchoring elements that can be actuated by means of one-man/one-hand grips arranged on the connecting strut and that are able to engage in the side panels. By means of the screw drives arranged on the protrusions of the anchoring boxes, the receiving shaft and the dough-processing tools arranged on the latter can be fixed at a precise height and operating position to give the respectively desired cutting and/or stamping depth.

### TECHNICAL FIELD

Longitudinal cutting devices for dough familiar in the prior art include a fixed shaft with side panels and clamping devices on both sides of the shaft for the cutting blades, while said clamping devices can be opened only individually. This means that to replace the processing tools, for instance for desired changes in their position on the tool reception shaft, the entire device in the case of only one person as operator and monitor had to be closely manipulated by that individual or two persons had to be available, one of them operating the clamp on each of the sides.

### BACKGROUND

The dough treatment tool, in particular blade-receiving shafts, are freely rotating or powered shafts with side bearing jaws, which are adjustable by means of adjusting screws.

Said tools, in particular blades, stamping rollers or the like, can be mounted in any desired manner onto the receiving shaft and can be affixed thereon in any desired positions.

The processing tools were previously affixed on the shaft by means of clamping screws in order to attain the necessary clamping force for them, and their use has heretofore demanded particular tools specifically adapted to their requirements.

A particularly important reason for the innovation was to substantially simplify the operation of devices for cutting and/or shaping, in particular stamping, dough; that is, displacement or switching of these tools was intended to be made manageable by just one person and to be rapid, using only a handgrip.

### SUMMARY

The present teaching relates to a novel multiple dough strip longitudinal cutting and/or stamping device, comprising a wide conveyor belt for, in particular, continuous feed of a wide dough strip, which is preferably kept at constant height, and, positioned above it, a receiving shaft, preferably power driven, equipped with a number of dough treatment tools, set apart from one another, in particular round blades and/or stamping discs or rollers, said device being characterized in that:
the receiving shaft in the area of both its ends is mounted rotatably in bearing jaws that are arranged so that they can be vertically displaced and adjusted in recesses of the two side panels of the device,
the two bearing jaws, in turn, are each vertically adjustable by means of a tool, in particular a screw drive for adjusting the cutting and/or stamping depth, arranged on the two anchoring boxes that are connected with one another by a connecting strut of a clamping lever that is arranged for folding pivotally and vertically on both sides likewise on the side panels of the device, said strut being aligned parallel to the receiving shaft,
the clamping lever is equipped with an anchoring mechanism which is arranged inside its connecting strut and reaches into the anchoring box on both its sides and which has anchoring elements that can be actuated by means of a one-man/one-hand grip arranged on the connecting strut and that are able to engage in the side panels of the device, and
by means of the screw drives arranged in the protrusions of the anchoring boxes, the receiving shaft and the tools arranged on the latter, in particular the circular blade and/or stamping rollers, can be fixed at a desired height and operating position, in particular to give the desired cutting and/or stamping depth.

The cutting and/or stamping tools can be inserted in the receiving shaft through the side panels of the device by means of precisely manufactured recesses in said panels.

The holding clamp of the shaft with the dough processing tools occurs by means of a clamping lever which very advantageously can be operated by just one person and with the use of one hand. Said clamping lever, in particular, can be equipped with a latching function, or else with a comparable position retention. Latching to fix the receiving shaft and tool together by means of rotatable mounting on both sides, or their release, that is “unhooking,” is accomplished by means of just one handle, which operates the anchoring elements on both sides of the clamping bar simultaneously and uniformly.

An additional component is a possible scale for precise positioning of the individual tools on the receiving shaft, which can be supplemented with a position indicator that is adjustable on a scaling strut.

The tool-receiving shaft, which is equipped with flexible bearings, preferably allows for automatic lifting of the tools away from the strip of dough to facilitate the displacement of said tools on the receiving shaft.

The lifting or folding of the receiving shaft with the tools can be achieved or facilitated in any desired manner, in particular by means of springs, gas pressure vaporizers, electrically or pneumatically.

Quick clamping of the cutting blade/cutting tools on the receiving shaft can be achieved in particular by means of clamping, such as with a cam lever, screw clamp or the like.

In the context of the present teaching, one embodiment is especially preferred, in which the aforementioned anchoring mechanism of the clamping lever includes two parts, configured with elongated holes symmetrically slanting toward one another and extending away from one another rising upward, and which are longitudinally displaceable with respect to one another inside the sleeve-like connecting strut on both sides, with the anchoring elements, in particular latching hooks, that can engage in the side panels of the device, such that one displaceable peg, which can be displaced diagonally to the same in each case, engages in the two diagonal elongated holes of the actuation bar parts by means of a self spring-loaded one-man/one-hand grip that can be displaced against the spring pressure slanting to the connecting strut, and thus ensures the displacement of the two anchoring bar parts with the anchoring hooks, in particular latching hooks.

The double release and anchoring mechanism just described in the connecting strut of the clamping lever, in addition to the inventively ensured new one-man/one-hand grip, has the advantage that, with the hand grip not actuated, it is completely fixed in the anchoring position, and yet can be released without problems by raising of the spring-loaded one-man/one-hand grip, after which there is no further obstacle to exchanging or repositioning the tool on the receiving shaft after moving the clamping lever upward, in particular after releasing the tool penetration depth screw drive.

With respect to the fixed-position, spaced-apart connection of the tools, that is, in particular, the circular blade and/or stamping roller, to the receiving shaft, it has been shown that these aforementioned dough processing tools can be immovably connected to the receiving shaft in each case, by means of a clamping ring with clamping screws, but preferably by means of quick-action clamping with quick-action clamping levers.

It has proved especially advantageous, in connection with the tool replacement function, if the bearing jaws of the receiving shaft are spring-loaded in each case with their rotation bearings in the recesses of the side panels of the new device. As a result, the upper parts of the bearing jaws are pushed upward, so that the receiving shaft becomes more accessible with the dough processing tools.

It should also be mentioned that changing or reciprocal repositioning of tools on the receiving shaft, which remains completely accessible after the clamping lever has been folded up, is substantively simplified or facilitated if the two side panels comprise a scaling strut with a scale that connects them with one another and is parallel to the receiving shaft and to the connecting strut of the clamping lever, and on which a positioning aid is displaceably mounted for precisely placed fixing of the individual circular blades and/or stamping rollers and for distancing them from one another on the receiving shaft, and if it can be fixed by means of fixing screws in every scale position on the scaling strut.

### BRIEF DESCRIPTION OF THE DRAWINGS

The present teaching is described more closely with reference to the drawings:

In diagonal view in each case: FIG. 1 shows the side panels on both sides, arranged on the frame of the new device, comprising recesses to receive bearing jaws, with the scaling struts connecting them to one another;

FIG. 2 shows the novel clamping lever equipped on both sides with screw drives for vertical adjustment of tools;

FIG. 3 shows the receiving shaft for the dough cutting blade and/or stamping roller with its rotation bearings in bearing jaws on both sides;

FIGS. 4 and 5 each show one of the circular blades with rapid locking and screw-clamping to fix it on the receiving shaft;

FIG. 6 shows the entire inventive device for cutting and/or stamping dough;

FIG. 7 shows a detail of the anchoring mechanism mounted in the clamping lever or in its anchoring boxes;

FIG. 8 shows the connecting strut of the clamping lever with the two anchoring elements, or latching hooks, projecting out of it on both sides;

and FIG. 9 shows in X-ray image-like manner the anchoring mechanism in the area of the one-man/one-hand grip of the clamping lever.

### DETAILED DESCRIPTION

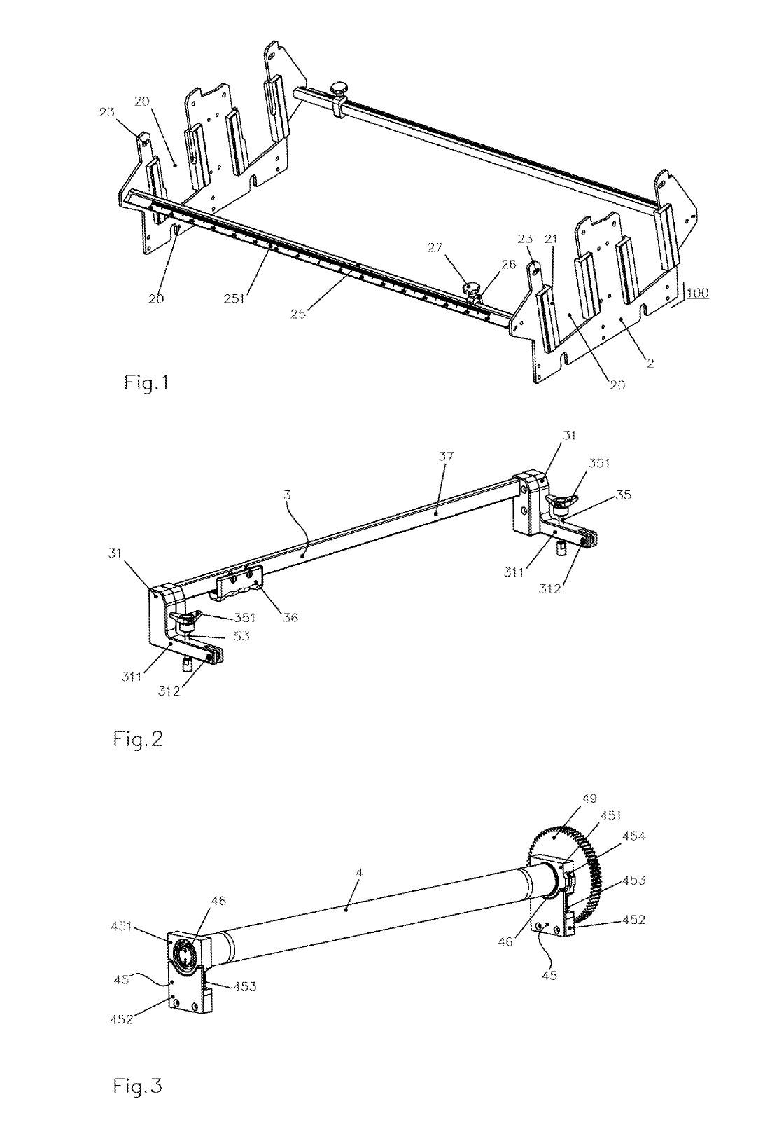

FIG. 1 shows the two side panels 2, in pairs in each case, arranged on both sides of the inventive device 100 (not shown in greater detail), so that their bilateral front part is connected with the scale 251 by means of the scaling strut 25. A tool positioning aid 26 is freely movable on the strut 25 and can be fixed in any selected position on the strut 25 with the rotation grip by means of a fixing screw 27. The two side panels 2 comprise on the front end two receiving recesses 20, each having two edges parallel to one another with guide tracks 21, in addition to two latching recesses 23 for the anchoring elements of the clamping lever that is depicted in greater detail in the following FIG. 2.

FIG. 2, in which reference numbers are otherwise unchanged, shows the clamping lever 3 according to the present teaching with the anchoring boxes 31 connected on both sides to its connecting strut 37, each having protrusions 311 pointing forward from it here at an angle of about 90 degrees and each with pivotable rotation holes 312. The two aforementioned protrusions 311 are each traversed by pressure screws, which serve as screw drives 35 intended for adjusting heights and thus the depths of cutting by the blade and/or stamping by the stamping roller with the rotation handle 351.

Shown in FIG. 3, in which reference numbers are otherwise unchanged, is the receiving shaft 4 designed for insertion of the dough cutting and/or stamping tools that can be fixed on it at a freely selected distance, with its two terminal bearing jaws 45 visible, which comprise the rotation bearings 46 for mounting the receiving shaft 4. FIG. 3 also depicts two parts 451, 452 of the bearing jaws 45, where in each case the upper portion 451 is configured with guide grooves 454 and is spring loaded from the base portion 452 with an upward-acting spring 453.

As likewise shown in FIG. 3, the receiving shaft 4, at its right-hand end, bears a gearwheel 49 that engages with a gearwheel of a shaft drive unit, which is not illustrated.

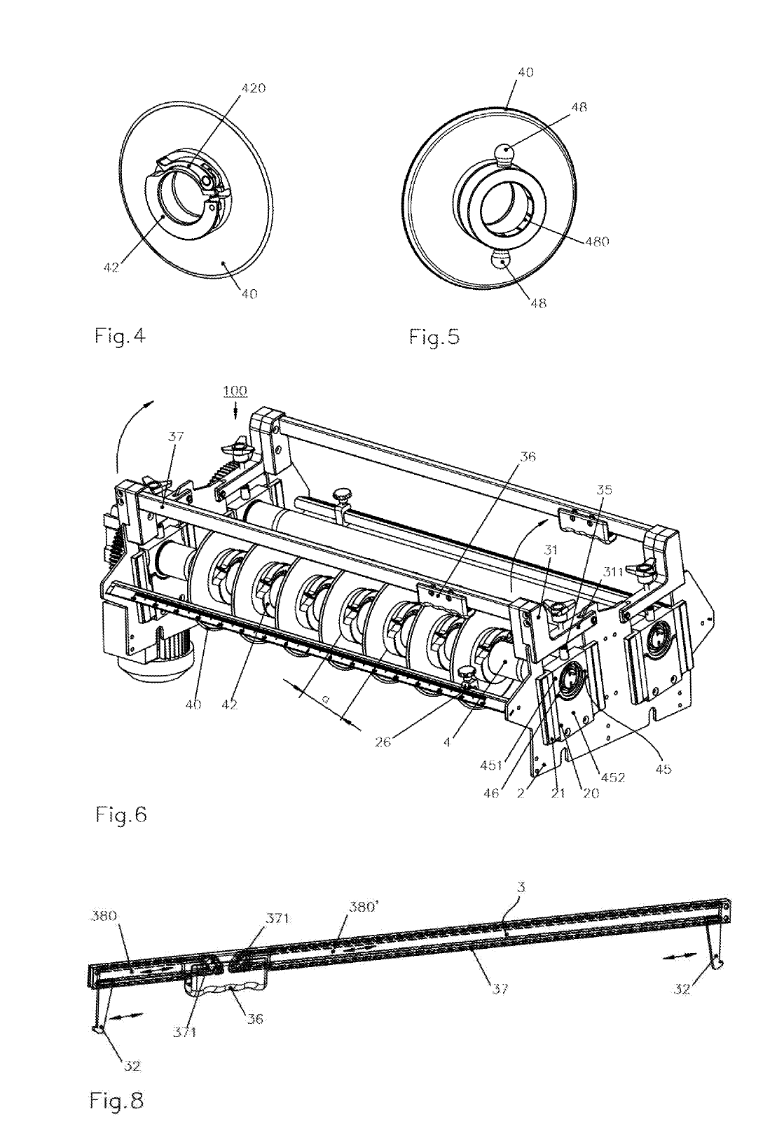

In addition, FIGS. 4 and 5, with reference numbers otherwise unchanged, both show two types of the new clamping fixing device of the dough cutting blades 40 on the (not illustrated here) receiving shaft 4, namely in FIG. 4 a solution, particularly preferred in the scope of the invention, with a central ring having a quick-action clamping lock 42 with quick-action clamping lever 420, and in FIG. 5 a divided central clamping ring 480 that can be securely clamped to the shaft 4 by means of two clamping screws 48.

FIG. 6, in which reference numbers are otherwise unchanged, shows the entire device 100 for longitudinal cutting and/or stamping of dough, which includes, combined in one structure, the components illustrated in greater detail in the previously discussed FIGS. 1 through 4:

The figure shows how, in the two front-placed receiving recesses 20 of the two side panels 2, both of the two-part bearing jaws 45, which can be guided at varying heights in the tracks 21, are also arranged in the rotation bearings 46 mounted in their upper parts 451 for the tool receiving shaft 4, here with uniformly spaced rotation blades 40 fixed to them by means of quick-action locks 42.

The two side panels 2 of FIG. 6 are connected to one another by two scaling struts 25 or the like, wherein a positioning aid 26, which can be displaced and fixed there, is arranged on each side of the two struts 25.

The two bearing jaws 45 are inserted into the recesses 20; their upper parts 451 with rotation bearings 46 of the receiving shaft 4 are connected with the lower parts 452 by means of non-visible compression springs 453, which press the upper parts 451 upward.

Both bearing jaws 45 or their upper parts 451 are connected by a height adjusting screw drive 35 with the angled protrusions 311 of the two anchoring boxes 31 (joined together by means of a connecting strut 37 with one-man/one-hand grip 36) of the clamping lever 3 linked on both sides in each case to the aforementioned side panel 2. By raising the one-man/one-hand grip 36 or pressing it down to the connecting strut 37, it is possible to release the latching hooks 32 mounted in the two anchoring boxes 31 from the anchoring in the side panels 2, and the clamping lever 3 hinged to the side panels 2 can then be folded upward, as indicated by two curved arrows, so that the circular blades 40 become accessible and said blades can be displaced, for example, as needed, into other positions on the tool receiving shaft 4.

The two side panels 2 of the device 100 shown in FIG. 6 are constructed in two parts, almost symmetrical to one another, and likewise, in each of their “rear” second recesses, a mounting bar can be inserted for the rotation mounting of a second receiving shaft, which for instance contains rotary brushes and can theoretically be constructed and arranged exactly like the previously described tool receiving shaft 4 according to the invention.

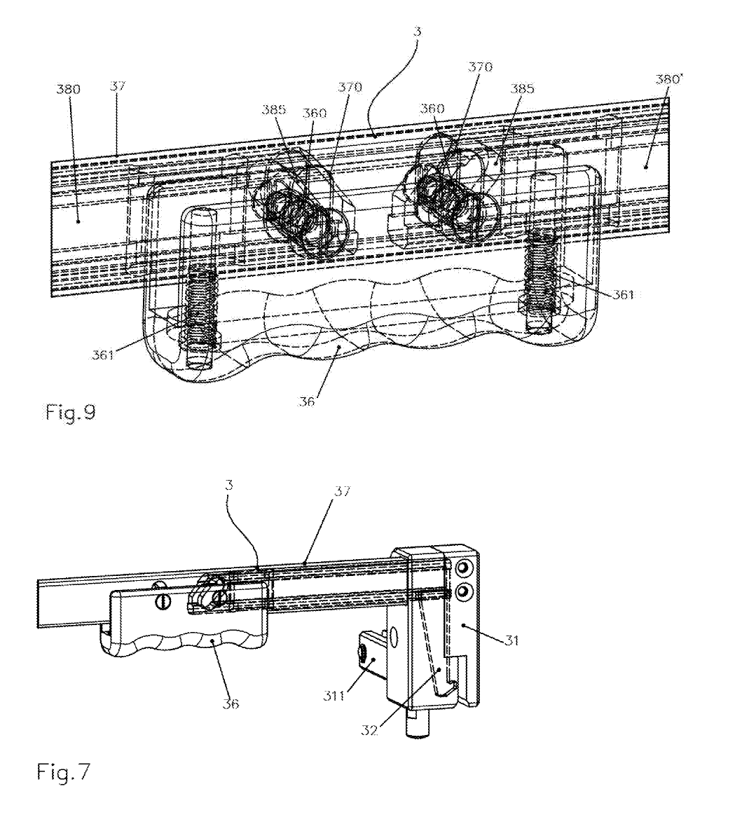

FIG. 7, with reference numbers otherwise unchanged, shows a right-hand part of the connecting strut 37 of the clamping lever 3 with the anchoring box 31 with angled protrusion 311, so that from the connecting strut 37 the latching hook 32 of the clamping lever 3 can be released from a catch opening or from a protrusion of the side panel 2 by raising the one-man/one-hand operating grip 36, or can be moved into anchoring position upon the release of the grip 36.

FIG. 8, with reference numbers otherwise unchanged, shows an overall view of the hollow connecting strut 37 with the movable one-man/one-hand grip 36 asymmetrically mounted to it, easily accessible from the left-hand side, in elongated holes 371 oriented diagonally to its course with a movable peg inside it, and by means of which, in the sleeve-type connecting strut 37, mutually opposing laterally displaceable anchoring bar parts 380, 380′ can be laterally displaced outward or inward in opposing manner in each case with the latching hooks 32.

FIG. 9, with reference numbers otherwise unchanged, shows in detail the anchoring mechanism of the clamping lever 3 with the two anchoring bar parts 380, 381, of unequal length and laterally displaceable inside it in contrary motion to one another, with their two diagonal elongated holes 385 extending apart in the upward direction, into each of which a peg 360 engages, which is displaceable in elongated holes 370 perpendicular to the course of the connecting strut 3, said peg being part of the operating hand grip 36, which is held in each case in a “lower” position by means of springs 361 and can be raised against the spring load, so that the two anchoring bar parts 380, 380′ in the connecting strut 37 and with them the latching bars 32 (not shown here) that can be displaced laterally with respect to one another can be released from a latching position that engages in the side panels 2 (not shown here), and thus makes possible the previously described upward folding of the clamping lever 3.

1. A device for multiple longitudinal cutting and/or stamping of dough strips, comprising a wide conveyor belt for a continuous feed of a wide dough strip, which is kept at constant height, and, positioned above it, a receiving shaft equipped with a number of dough treatment tools, set apart from one another, in particular round blades and/or stamping discs or rollers, wherein:
the receiving shaft at its ends is mounted rotatably with both its ends in bearing jaws that are arranged so that they can be vertically displaced and adjusted in recesses of the two side panels of the device,
the two bearing jaws, in turn, are each vertically adjustable by means of a tool, in particular a screw drive for adjusting the cutting and/or stamping depth, arranged on the two anchoring boxes that are connected with one another by a connecting strut of a clamping lever that is arranged for folding pivotably and vertically on both sides likewise on the side panels of the device, said strut being aligned parallel to the receiving shaft,
the clamping lever is equipped with an anchoring mechanism which is arranged inside its connecting strut and reaches into the anchoring boxes on both its sides and which has anchoring elements that can be actuated by means of a one-man/one-hand grip arranged on the connecting strut and that are able to engage in the side panels of the device, and
by means of the screw drives arranged in the protrusions of the anchoring boxes, the receiving shaft, together with the circular blades and/or stamping rollers arranged on the latter, can be fixed at a precisely desired height and operating position to give the respectively desired cutting and/or stamping depth.

2. The device according to claim 1, wherein the anchoring mechanism of the clamping lever includes two actuation bar parts, configured with elongated holes symmetrically slanting toward one another and extending away from one another rising upward, and which are longitudinally displaceable with respect to one another inside the sleeve-like connecting strut on both sides, with the anchoring elements, in particular latching hooks, that can engage in the side panels of the device, such that one displaced peg, which can be displaced diagonally to the same in each case, engages in the two diagonal elongated holes of the actuation bar parts by means of a self spring-loaded one-man/one-hand grip that can be displaced against the spring, in particular perpendicular to the connecting strut, and thus ensures the opposed displacing of the two anchoring bars with the anchoring hooks, in particular latching hooks.

3. The device according to claim 1, wherein the individual dough-processing tools, in particular the round blade and/or stamping roller, can each be affixed without a change of position to the receiving shaft by means of a clamping ring with clamping screws.

4. The device according to claim 1, wherein the bearing laws of the receiving shaft are spring-loaded with the rotation bearings in the recesses of the side panels.

5. The device according to claim 1, wherein the two side panels comprise a scaling strut with a scale that connects the two side panels with one another and is parallel to the receiving shaft and to the connecting strut of the clamping lever, and on which a positioning aid—for fixing the individual round blades and/or stamping rollers precisely in position and for arranging the distances between them on the receiving shaft—is displaceably mounted and can be fixed by fixing screws in every scale position on the scaling strut.

6. The device according to claim 1, wherein the receiving shaft is power driven.

7. The device according to claim 1, wherein the individual dough-processing tools, in particular the round blade and/or stamping roller, can each be affixed without a change of position to the receiving shaft by means of a quick-action clamping lock with quick-action clamping lever.
